(19) United States
(12) Patent Application Publication
(10) Pub. No.: US 2011/0131271 A1
(43) Pub. Date: Jun. 2, 2011

(54) APPARATUS AND METHOD FOR ALLOCATING AND RELEASING IMAGING DEVICE IN VIRTUALIZATION SYSTEM

(75) Inventors: Joon-Young JUNG, Seoul (KR); Ki-Ryong HA, Daejeon (KR); Jeun-Woo LEE, Daejeon (KR)

(73) Assignee: Electronics and Telecommunications Research Institute, Daejeon-city (KR)

(21) Appl. No.: 12/839,938

(22) Filed: Jul. 20, 2010

(30) Foreign Application Priority Data
Nov. 30, 2009 (KR) 10-2009-0117283

(51) Int. Cl. G06F 15/16

(52) U.S. Cl. 709/203; 709/226; 709/227

(57) ABSTRACT

The present invention relates to an apparatus and method for allocating and releasing an imaging device in a virtualization system. An image processing management module in the virtualization system, in response to an allocation command or a release command from the device management module, generates or removes an image processing module corresponding to the imaging device, and, upon generating the image processing module, transmits connection information on the image processing module to the imaging device so that image data from the virtual machine is transmitted and received between the imaging device and the image processing module. According to the present invention, it can be possible to establish a computing environment appropriate for an environment using various imaging devices in a ubiquitous environment by constituting a virtualization computing environment that allows a user to dynamically select an imaging device in a server where a plurality of imaging devices have been registered.

### CROSS REFERENCE TO RELATED APPLICATIONS

This application claims priority to Korean Patent Application No. 10-2009-0117283 filed on Nov. 30, 2009, the entire contents of which are herein incorporated by reference.

### BACKGROUND OF THE INVENTION

1. Field of the Invention

The present invention relates to an apparatus and method for allocating and releasing imaging device in virtualization system, and in particular to an apparatus and method for allocating and releasing an imaging device in a virtualization system, which can generate an image processing module corresponding to a remote image device so that a server in the virtualization system may transmit an image to the remote imaging device and provide session information of the image processing module to the remote imaging device so that image data may be communicated between the server and the imaging device.

2. Description of the Related Art

According to a server-based computing technology that performs most tasks in a server, the server executes an application program and a client may access the application program through a terminal emulator regardless of the type of client.

Accordingly, all of the tasks performed by a user using a terminal corresponding to the client are actually conducted in the server and the result is displayed on the screen of the terminal. Since the task that appears to be conducted in a personal computer is actually performed in the server, the client terminal does not require a storage device, such as a hard disk or a floppy disk unlike existing personal computers, and thus cost of the client terminal may be reduced.

Such a server-based computing technology provides an environment in which a number of users may access one server so that each of the users may independently execute different application programs. An emulator installed in the user's computer allows the terminal to access the server over a network to use application programs installed in the server.

In a known virtualization system, however, a user should enter session information of the server through a remote input/output device to have remote access to the server, and thus, the server cannot provide a proper computing environment to the user, in which the server dynamically selects an imaging device.

### SUMMARY OF THE INVENTION

An aspect of the present invention provides an apparatus and method for allocating and releasing an imaging device in a virtualization system, which may establish a computing environment appropriate for an environment using various imaging devices in a ubiquitous environment by constituting a virtualization computing environment that allows a user to dynamically select an imaging device in a server where a plurality of imaging devices have been registered so that the user may use an imaging device fitful to a situation.

According to an embodiment of the present invention, there is provided an apparatus for allocating and releasing an imaging device in a virtualization system, comprising: a server that allocates and releases the imaging device in the virtualization system, wherein the server comprises, a communication module that communicates with the imaging device and transmits/receives information for allocating and releasing the imaging device; a device management module that manages allocation and release of the imaging device corresponding to a plurality of virtual machines; and an image processing management module that generates or removes an image processing module corresponding to the imaging device in response to an allocation command or a release command from the device management module, and transmits connection information on the image processing module to the imaging device so that image data is transmitted and received between the imaging device and the image processing module when the image processing management module generates the image processing module.

The imaging device attempts to access the server based on the connection information of the image processing module transmitted from the image processing management module.

The imaging device processes image data from a virtual machine of the server to which the imaging device is allocated and externally outputs the image data.

After the imaging device is released, the device management module transmits to the image processing management module and the imaging device a message notifying that the imaging device has been released.

When receiving from the device management module a message notifying that the imaging device is released and releasing the connection to the image processing module, the image processing management module removes the image processing module corresponding to the imaging device.

A plurality of imaging devices may be allocated to the server.

According to an embodiment of the present invention, there is provided a method of allocating an imaging device in a virtualization system, including: requesting allocation of a device from a server to an imaging device; allocating an imaging device to a virtual machine according to a response from the imaging device to generate an image processing module corresponding to the imaging device; establishing a connection between the imaging device and the image processing module of the server by providing connection information of the image processing module to the imaging device; and transmitting image data from the virtual machine to the imaging device to process the image data.

Generating the image processing module includes confirming whether the imaging device may be allocated according to the response from the imaging device.

The method further includes receiving a connection request from the imaging device based on the connection information of the image processing module, wherein establishing the connection is performed in response to the connection request of the imaging device.

The image data is outputted from any one of a plurality of virtual machines in the server.

The image processing module is generated corresponding to each of a plurality of imaging devices that are allocated in generating the image processing module.

According to an embodiment of the present invention, there is provided a method of releasing an imaging device in a virtualization system, including: releasing an imaging device allocated to a virtual machine; transmitting a message notifying the release of the imaging device to the imaging device; confirming a connection state between the imaging device and an image processing module generated for processing image data of the imaging device; and removing the image processing module when the connection between the imaging device and the image processing module corresponding to the imaging device is released based on the message.

The method further includes updating device release information of the message in the imaging device.

The connection between the imaging device and the image processing module corresponding to the imaging device is released by the imaging device in removing the image processing module.

The present invention may establish a computing environment appropriate for an environment using various imaging devices in a ubiquitous environment by constituting a virtualization computing environment that allows a user to dynamically select an imaging device in a server where a plurality of imaging devices have been registered so that the user may use an imaging device applicable to a situation.

### BRIEF DESCRIPTION OF THE DRAWINGS

FIGS. 1 and 2 are views illustrating a construction of an apparatus for allocating and releasing an imaging device in a virtualization system according to an embodiment of the present invention;

FIG. 3 is a flowchart illustrating a method of allocating an imaging device in a virtualization system according to an embodiment of the present invention; and

FIG. 4 is a flowchart illustrating a method of releasing an imaging device in a virtualization system according to an embodiment of the present invention.

### DETAILED DESCRIPTION OF THE PREFERRED EMBODIMENTS

Hereinafter, embodiments of the present invention will be described with reference to the accompanying drawings.

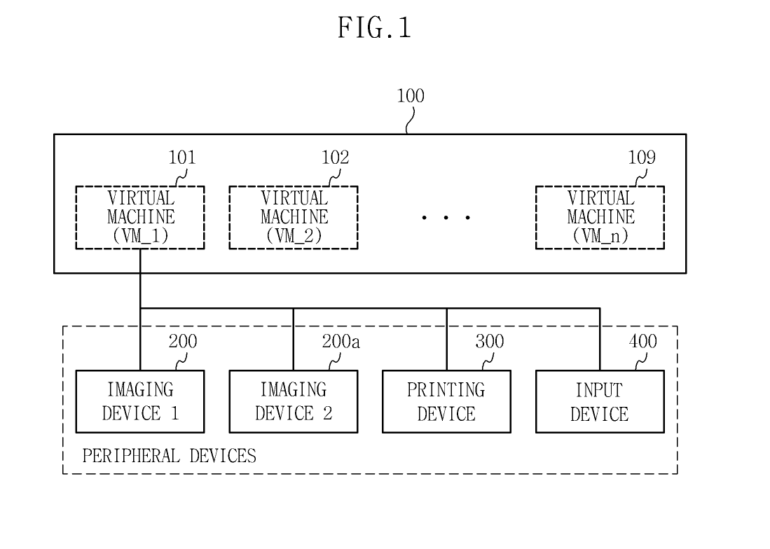

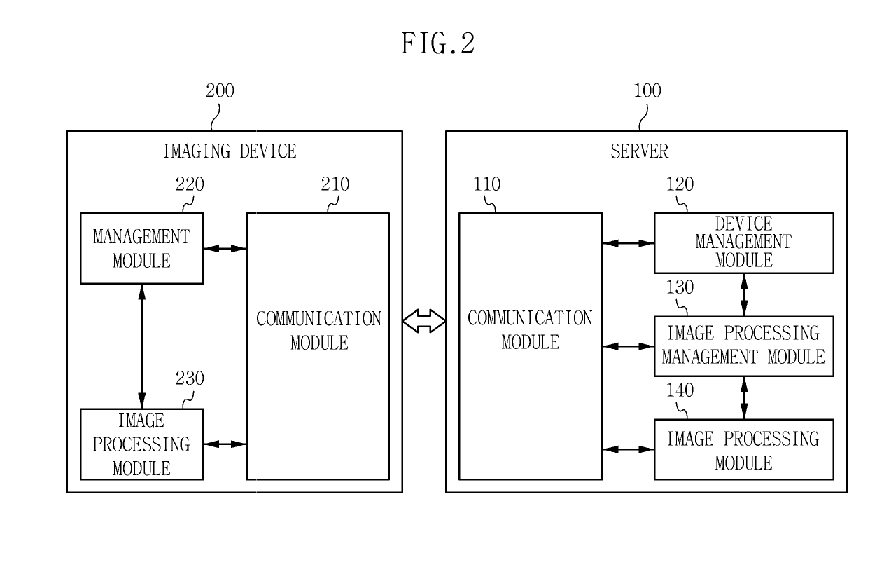

FIGS. 1 and 2 are views illustrating a construction of an apparatus for allocating and releasing an imaging device in a virtualization system according to an embodiment of the present invention.

FIG. 1 is a block diagram illustrating a virtualization system according to an embodiment of the present invention. Referring to FIG. 1, the virtualization system includes a server 100 that provides a predetermined service to users. The server 100 includes a plurality of virtual machines (“VMs”) 101, 102, and 109 to establish an input/output computing environment.

The server 100 establishes a computing environment having peripheral devices as input/output devices by using any one of the virtual machines 101, 102, and 109.

The peripheral devices include all types of devices that may perform input/output functions, such as, for example, an imaging device 200, such as a TV, a monitor, a PDA, or a projector, a printing device 300, such as a printer, or an input device 400, such as a key board or a mouse.

In particular, the server 100 in the virtualization system controls a connection state of the imaging devices 200 and 200a among the plurality of peripheral devices.

That is, the server 100 controls a connection state of the plurality of imaging devices 200 and 200a and data. The virtual machines 101, 102, and 109 establish a computing environment for each of the imaging devices 200 and 200a in response to a request from the server 100.

The server 100 determines whether the imaging devices 200 and 200a are available to transmit and receive an image to/from the imaging devices 200 and 200a. Thereafter, the server 100 prepares for transmission and receipt of an image to/from the imaging devices 200 and 200a. That is, the server 100 provides session information to the imaging devices 200 and 200a so that a connection for the image transmission can be established between the imaging devices 200 and 200a and the server 100 and then communicates image data with the imaging devices 200 and 200a.

By doing so, the server 100 of a virtualization system according to an embodiment of the present invention may transmit an image from each of the virtual machines 101, 102, and 109 executed in the server 100 to the various imaging devices 200 and 200a in a ubiquitous environment dynamically selected.

A construction of an apparatus for allocating and releasing an imaging device in a virtualization system according to an embodiment of the present invention will be described in greater detail with reference to FIG. 2.

FIG. 2 is a block diagram illustrating a construction of a device for allocating and releasing an imaging device in a virtualization system according to an embodiment of the present invention, wherein the construction includes a server 100 and an imaging device.

The server 100 includes a communication module 110, a device management module 120, an image processing management module 130, and an image processing module 140.

The communication module 110 is connected to at least one imaging device 200 to communicate data with the imaging device 200. The communication module 110 transmits and receives information to allocate and release the imaging device 200 connected to the communication module 110.

The device management module 120 manages a connection state of a plurality of imaging devices 200 that may be connected to the communication module 110.

The image processing management module 130 performs an allocation and release command on the imaging device 200 in response to a control command from the device management module 120. Further, the image processing management module 130 generates the image processing module 140 corresponding to the imaging device 200 upon performing the allocation command on the imaging device 200. The image processing management module 130 removes the image processing module 140 corresponding to the imaging device 200 upon performing the release command on the imaging device 200.

As described above, the image processing module 140 is generated and removed by the image processing management module 130. When the image processing module 140 is completely generated by the image processing management module 130, the image processing module 140 sends session information of the image processing module 140 to the image processing management module 130 together with a message of notifying the generation was complete.

The image processing management module 130 sends session information of the image processing module 140 to the imaging device 200 for transmission and reception of image data between the imaging device 200 and the server 100.

The image processing module 140 is connected to the imaging device 200 through the communication module 110 using the session information from the image processing management module 130. The image processing module 140 transfers a control message from the server 100 to the imaging device 200 or processes a control message from the imaging device 200. Further, the image processing module 140 processes image message of the virtual machine and transmits the processed image data to the imaging device 200 through the communication module 110.

The imaging device 200 includes a communication module 210, a management module 220, and an image processing module 230.

The communication module 210 is connected to the communication module 110 of the server 100 to receive an allocation command and a release command of the imaging device 200 and transmits a response signal to the server 100 in response to the command.

The management module 220 manages all the resources that may be utilized by the imaging device 200. When the server 100 requests the allocation of the imaging device 200, the management module 220 determines whether a device may be allocated as the imaging device 200 and then transmits a response to the server 100 through the communication module 210. Further, the management module 220 manages information on connection to the server 100.

The image processing module 230 communicates a control message for image processing with the image processing module 140 of the server 100 via the communication module 210 and processes image data received from the server 100.

When receiving the session information on the image processing module 140 of the server 100 after the allocation of the imaging device 200 in response to the request from the server 100, the image processing module 230 attempts to access the image processing module 140 of the server 100 based on the received session information.

Upon receiving a release command of the imaging device 200 from the server 100, the management module 220 updates information regarding the release and releases the connection to the server 100.

An operation of the present invention configured as above will be described below.

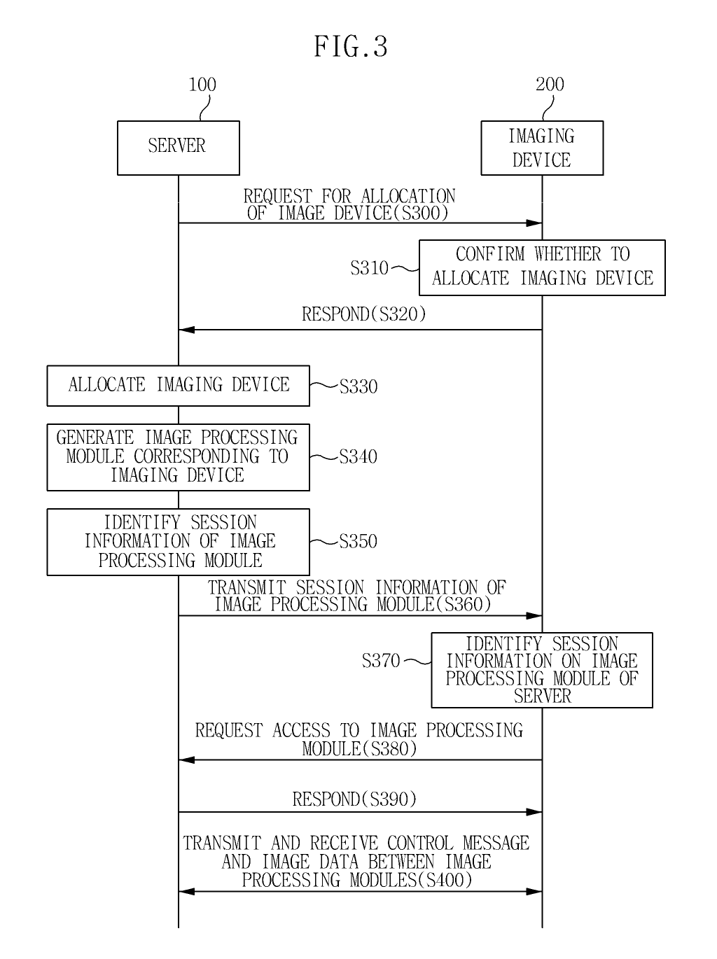

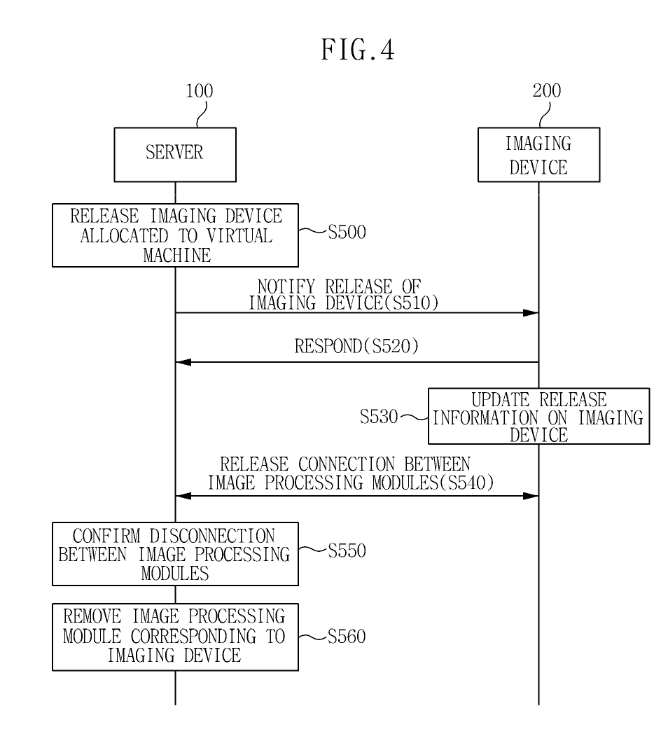

FIGS. 3 and 4 are flowcharts illustrating operations included in an image control method by a virtualization system according to an embodiment of the present invention, wherein FIG. 3 depicts an operation of allocating an imaging device to a virtual machine of a server and FIG. 4 depicts an operation of releasing the imaging device allocated to the virtual machine of the server.

Referring to FIG. 3, the device management module 120 of the server 100 requests allocation of a device to the imaging device 200 (S300).

In response to the device allocation request from the server 100, the management module 220 of the imaging device 200 confirms whether a device may be allocated as the imaging device 200 (S310) and then transmits a response message to the server 100 (S320).

When receiving from the imaging device 200 a response that the device may be allocated as the imaging device 200, the device management module 120 of the server 100 allocates the imaging device 200 to a virtual machine (S330). Thereafter, the device management module 120 of the server 100 notifies the image processing management module 130 that a new imaging device 200 has been allocated.

When the new imaging device 200 is allocated, the image processing management module 130 generates the image processing module 140 corresponding to the new imaging device 200 (S340).

When receiving a generation result and session information from the image processing module 140, the image processing management module 130 identifies the session information of the image processing module 140 (S350) and transmits the session information to the imaging device 200 (S360).

The management module 220 of the imaging device 200 transfers the session information of the image processing module 140 received from the server 100 to the image processing module 230 of the imaging device 200, and the image processing module 230 of the imaging device 200 identifies the received session information (S370) and then attempts to access the image processing module 140 of the server 100 (S380).

Then, when there is a response from the image processing module 140 of the server 100 (S390), a connection is established between the image processing module 140 of the server 100 and the image processing module 230 of the imaging device 200 so that a control message and image data for image processing may be transmitted and received (S400).

Referring to FIG. 4, the device management module 120 of the server 100 releases the imaging device 200 allocated to the virtual machine of the server 100 (S500) and requests the imaging device 200 to release the device (S510).

In response to the request of releasing the imaging device 200 from the server 100, the management module 220 of the imaging device 200 transmits a response message to the server 100 (S520) and updates release information on the imaging device 200 (S530).

Thereafter, the management module 220 of the imaging device 200 releases the connection between the image processing module 140 of the server 100 and the image processing module 230 of the imaging device 200 (S540).

The image processing module 140 of the server 100 confirms disconnection between the image processing module 140 of the server 100 and the image processing module 230 of the imaging device 200 (S550), and notifies the image processing management module 130 that the connection to the imaging device 200 was released.

Then, the image processing management module 130 removes the image processing module 140 corresponding to the released imaging device 200 (S560).

As described above, the exemplary embodiments have been described and illustrated in the drawings and the description. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. An apparatus for allocating and releasing an imaging device in a virtualization system, comprising:
a server that allocates and releases the imaging device in the virtualization system, wherein the server comprises:
a communication module that communicates with the imaging device and transmits/receives information for allocating and releasing the imaging device;
a device management module that manages allocation and release of the imaging device corresponding to a plurality of virtual machines; and
an image processing management module that generates or removes an image processing module corresponding to the imaging device in response to an allocation command or a release command from the device management module, and transmits connection information on the image processing module to the imaging device so that image data is transmitted and received between the imaging device and the image processing module when the image processing management module generates the image processing module.

2. The apparatus for allocating and releasing an imaging device in a virtualization system according to claim 1, wherein the imaging device attempts to access the server based on the connection information of the image processing module transmitted from the image processing management module.

3. The apparatus for allocating and releasing an imaging device in a virtualization system according to claim 1, wherein the imaging device processes image data from a virtual machine of the server to which the imaging device is allocated, and externally outputs the image data.

4. The apparatus for allocating and releasing an imaging device in a virtualization system according to claim 1, wherein after the imaging device is released, the device management module transmits to the image processing management module and the imaging device a message notifying that the imaging device has been released.

5. The apparatus for allocating and releasing an imaging device in a virtualization system according to claim 1, wherein when receiving from the device management module a message notifying that the imaging device is released and releasing the connection to the image processing module, the image processing management module removes the image processing module corresponding to the imaging device.

6. The apparatus for allocating and releasing an imaging device in a virtualization system according to claim 1, wherein a plurality of imaging devices may be allocated to the server.

7. A method of allocating an imaging device in a virtualization system, comprising:
requesting allocation of a device from a server to an imaging device;
allocating an imaging device to a virtual machine according to a response from the imaging device to generate an image processing module corresponding to the imaging device;
establishing a connection between the imaging device and the image processing module of the server by providing connection information of the image processing module to the imaging device; and
transmitting image data from the virtual machine to the imaging device to process the image data.

8. The method according to claim 7, wherein generating the image processing module includes confirming whether the imaging device may be allocated according to the response from the imaging device.

9. The method according to claim 7, further comprising:
receiving a connection request from the imaging device based on the connection information of the image processing module,
wherein establishing the connection is performed in response to the connection request of the imaging device.

10. The method according to claim 7, wherein the image data is outputted from any one of a plurality of virtual machines in the server.

11. The method according to claim 7, wherein the image processing module is generated corresponding to each of a plurality of imaging devices that are allocated in generating the image processing module.

12. A method of releasing an imaging device in a virtualization system, comprising:
releasing an imaging device allocated to a virtual machine;
transmitting a message notifying the release of the imaging device to the imaging device;
confirming a connection state between the imaging device and an image processing module generated for processing image data of the imaging device; and
removing the image processing module when the connection between the imaging device and the image processing module corresponding to the imaging device is released based on the message.

13. The method according to claim 12, further comprising:
updating device release information of the message in the imaging device.

14. The method according to claim 13, wherein the connection between the imaging device and the image processing module corresponding to the imaging device is released by the imaging device in removing the image processing module.
